(19) United States
(12) Patent Application Publication
(10) Pub. No.: US 2014/0240311 A1
(43) Pub. Date: Aug. 28, 2014

(54) METHOD AND DEVICE FOR PERFORMING TRANSITION BETWEEN STREET VIEW IMAGES

(71) Applicant: Tencent Technology (Shenzhen) Company Limited, Shenzhen City (CN)

(72) Inventors: Kun XU, Shenzhen City (CN); Jianyu Wang, Shenzhen City (CN); Baoli Li, Shenzhen City (CN); Chengjun Li, Shenzhen City (CN); Haozhi Huang, Shenzhen City (CN)

(73) Assignee: Tencent Technology (Shenzhen) Company Limited, Shenzhen City (CN)

(21) Appl. No.: 14/267,843

(22) Filed: May 1, 2014

Related U.S. Application Data
(63) Continuation of application No. PCT/CN2013/087422, filed on Nov. 19, 2013.

(30) Foreign Application Priority Data
Jan. 30, 2013 (CN) 201310037566.7

(51) Int. Cl. G06K 9/00; G06T 3/40; G06T 17/00

(52) U.S. Cl. CPC G06K 9/00214; G06T 17/00; G06T 3/4038; G06T 2200/32
USPC 345/419

(57) ABSTRACT

Transitions between street view images are described. The described techniques include: obtaining an original street view image and a target street view image; constructing a three-dimensional model corresponding to the original street view image by three-dimensional modeling; obtaining matching pairs of feature points that are extracted from the original street view image and the target street view image, and simulating a virtual camera in the three-dimensional model according to matching pairs of feature points to capture street view image sequence; and switching from the original street view image to the target street view image according to the street view image sequence. Transition stability is thereby improved.

### CROSS REFERENCE TO RELATED APPLICATION

This application is a continuation application of International Application No. PCT/CN2013/087422, filed Nov. 19, 2013, entitled “METHOD AND DEVICE FOR PERFORMING TRANSITION BETWEEN STREET VIEW IMAGES”, which claims priority from Chinese patent application No. CN201310037566.7, filed on Jan. 30, 2013, the disclosures of which are herein incorporated by reference in their entirety.

### TECHNICAL FIELD

The present disclosure relates generally to the field of virtual reality technology, and more particularly to a method, device, and non-transitory computer-readable storage medium for performing transition between street view images.

### BACKGROUND

Street view roaming is an important feature of an electronic map, providing people with an immersive experience to the place to be viewed without even stepping out of home. A user is allowed to start street view roaming to view panoramic images of a selected site by clicking an icon of the electronic map.

During street view roaming, what the user sees at a moment is only a part of a panoramic image. When the command to the next location is triggered, the panoramic image corresponding to the next location will be loaded, so as to move forward from a part of the present panoramic image to a part of the panoramic image corresponding to the next location.

In traditional approach for performing transition, a pre-recorded video is directly transferred and played to the user from the server via the Internet. However, this server and Internet based transition method will be affected by network bandwidth, server storage capacity and many other factors, which cannot guarantee the transition stability of street view images.

### SUMMARY

To address the aforementioned deficiencies and inadequacies, a method, device and non-transitory computer-readable storage medium for performing transition between street view images are provided, which can improve the transition stability.

According to one aspect of the disclosure, a method for performing transition between street view images includes the steps of:

obtaining an original street view image and a target street view image;

constructing a three-dimensional model corresponding to the original street view image by three-dimensional modeling;

obtaining matching pairs of feature points that are extracted from the original street view image and the target street view image, and simulating a virtual camera in the three-dimensional model according to matching pairs of feature points to capture street view image sequence;

switching from the original street view image to the target street view image according to the street view image sequence.

According to a further aspect of the disclosure, a device for performing transition between street view images includes:

a street view image obtaining module, configured to obtain an original street view image and an target street view image;

a modeling module, configured to construct a three-dimensional model corresponding to the original street view image by three-dimensional modeling;

a camera stimulation module, configured to obtain matching pairs of feature points that are extracted from the original street view image and the target street view image, and to simulate by a virtual camera in the three-dimensional model according to matching pairs of feature points to capture street view image sequence;

a switching module, configured to switch from the original street view image to the target street view image according to the street view image sequence.

According to still a further aspect of the disclosure, a non-transitory computer-readable storage medium comprising an executable program to execute a method for performing transition between street view images, the method includes:

obtaining an original street view image and a target street view image;

constructing a three-dimensional model corresponding to the original street view image by three-dimensional modeling;

obtaining matching pairs of feature points that are extracted from the original street view image and the target street view image, and simulating a virtual camera in the three-dimensional model according to matching pairs of feature points to capture a street view image sequence; and

switching from the original street view image to the target street view image according to the street view image sequence.

By the above method, device and non-transitory computer-readable storage medium for performing transition between street view images, an original street view image and a target street view image are obtained, and a three-dimensional model corresponding to the original street view image is constructed by three-dimensional modeling; matching pairs of feature points that are extracted from the original street view image and the target street view image are obtained, according to which a virtual camera stimulation is performed in the three-dimensional model to capture street view image sequence; transition from the original street view image to the target street view image according to the street view image sequence is further performed. This eliminates the need of obtaining a pre-recorded transition video from the server, shields the influence of various factors, and improves the transition stability of street view images.

### BRIEF DESCRIPTION OF THE DRAWINGS

FIG. 1 is a diagram showing a method for performing transition between street view images in one embodiment of the present disclosure.

FIG. 2 is a diagram showing a method for obtaining an original street view image and a target street view image of FIG. 1.

FIG. 3 is a schematic diagram showing panoramic image capture in one embodiment of the present disclosure.

FIG. 4 is a diagram showing a method for constructing a three-divisional model corresponding to the original street view image of FIG. 1.

FIG. 5 is a schematic diagram showing the construction of a rectangular box model of the original street view image in one embodiment of the present disclosure.

FIG. 6 is a schematic diagram showing a rectangular box model in one embodiment of the present disclosure.

FIG. 7 is a diagram showing a method for detecting the extending direction of a road in the original street view image of FIG. 5.

FIG. 8 is a diagram showing a method for performing transition between street view images in another embodiment of the present disclosure.

FIG. 9 is a diagram showing a method for obtaining matching pairs of feature points that are extracted from the original street view image and the target street view image, and simulating a virtual camera in the three-dimensional model according to matching pairs of feature points to capture street view image sequence in one embodiment of the present disclosure.

FIG. 10 is a diagram showing a method for switching from the original street view image to the target street view image according to the street view image sequence in one embodiment of the present disclosure.

FIG. 11 is a schematic diagram showing an application of a method for performing transition between street view images in one embodiment of the present disclosure.

FIG. 12 is a structural schematic diagram showing a device for performing transition between street view images in one embodiment of the present disclosure.

FIG. 13 is a structural schematic diagram showing the street view image obtaining module of FIG. 12.

FIG. 14 is a structural schematic diagram showing the modeling module of FIG. 12.

FIG. 15 is a structural schematic diagram showing a device for performing transition between street view images in another embodiment of the present disclosure.

FIG. 16 is a structural schematic diagram showing a camera stimulation module in one embodiment of the present disclosure.

FIG. 17 is a structural schematic diagram showing a switching module in one embodiment of the present disclosure.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

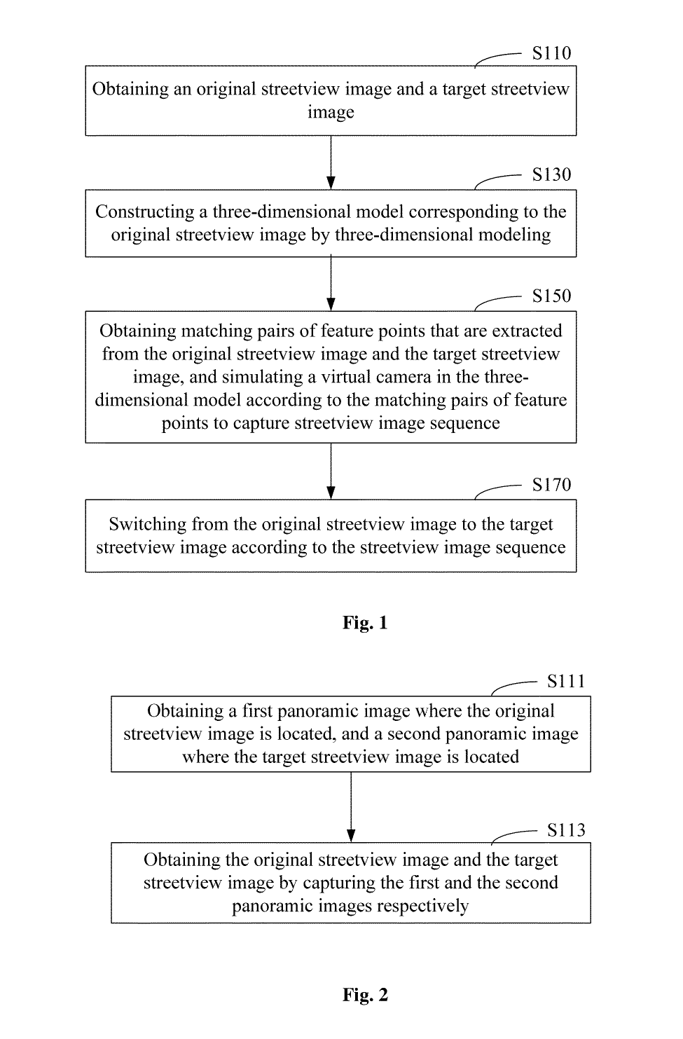

As shown in FIG. 1, a method for performing transition between street view images in one embodiment of the present disclosure includes the following steps.

Step S102, obtaining an original street view image and a target street view image.

In the embodiment, an original street view image is the street view image that is currently being displayed in the display window, and a target street view image is the street view image that is expected to be loaded and displayed. For example, the original street view image and the target street view image correspond respectively to two adjacent locations. When the user browses the original street view image in the display window and triggers an instruction of going to the next location, the target street view image will be loaded and displayed in the display window.

Step S130, constructing a three-dimensional model corresponding to the original street view image by three-dimensional modeling.

In one embodiment, a three-dimensional model of the original street view image may be constructed, by which the geometric information of each point of the original street view image may be obtained.

Step S150, obtaining matching pairs of feature points that are extracted from the original street view image and the target street view image, and simulating a virtual camera in the three-dimensional model according to matching pairs of feature points to capture street view image sequence.

In one embodiment, each matching pair of feature points include both a feature point of the original street view image and a feature point of the target street view image, wherein the feature point of the target street view image matches that of the original street view image.

A virtual camera is stimulated in the three-dimensional model according to the matching pairs of feature points and moved to capture the street view image sequence, the street view image sequence including a series of street view images obtained by shooting.

Step S170, switching from the original street view image to the target street view image according to the street view image sequence.

In one embodiment, the street view image sequence is played frame by frame starting from the original street view image, and street view images included in the street view image sequence are displayed one by one in the display window, so as to realize smooth transition from the original street view image to the target street view image, displaying to the user the natural and smooth transformation process between the original street view image and the target street view image.

As shown in FIG. 2, in one embodiment, the above Step S110 further includes:

Step S111, obtaining a first panoramic image where the original street view image is located, and a second panoramic image where the target street view image is located.

In one embodiment, a panoramic image is a 360-degree picture photographed by a photographing device at a fixed point, whereas a street view image is obtained by a single shot, and thus is part of a panoramic image. A plurality of street view images can be spliced together to form a panoramic image.

Step S113, obtaining an original street view image and a target street view image by capturing the first and the second panoramic images respectively.

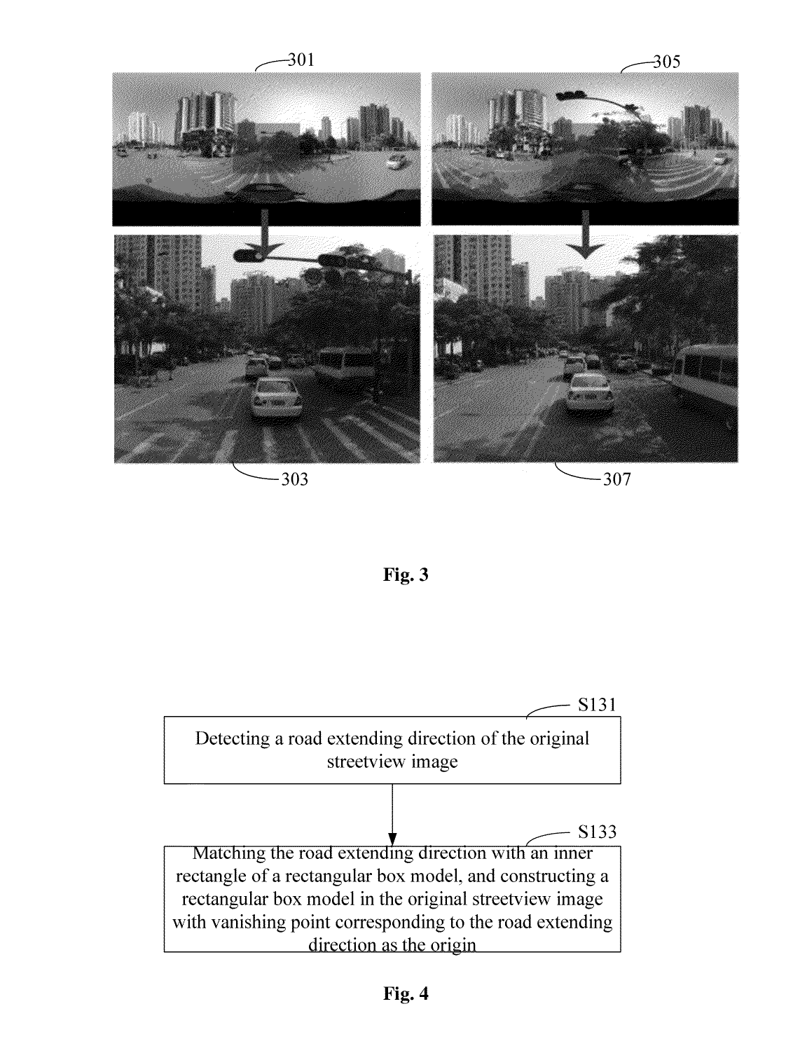

In the embodiment, as shown in FIG. 3, an appropriate part of the first panoramic image 301 is captured as the original street view image 303, and an appropriate part of the second panoramic image 305 is captured as the target street view image 307.

In one embodiment, the above Step S113 may include setting the size of image plane according to the size of the display window, and capturing according to the size of image plane to obtain a first image plane of the first panoramic image, and a second image plane of the second panoramic image, i.e., the original street view image and the target street view image.

In the embodiment, the display window is used to display images or pictures to the user. For example, the display window is the browser window.

The first and the second panoramic images are captured according to the set size of image plane to obtain a first image plane and a second image plane, wherein the first image plane is the original street view image, and the second image plane is the target street view image.

In a preferred embodiment, in order to ensure the accuracy of image transition, the size of the image plane may be larger than the size of the display window. For example, if the size of the display window is (W, H), then the size of the image plane may be (λM, λH), wherein λ is a value greater than 1, typically set to be such as 2 or a larger value.

By setting the size of the image plane to be larger than the size of the display window, the image plane obtained by capturing the panoramic image will be larger than the image the user actually sees, which further allows smooth and accurate transition when the user is back-viewing the previous street view image from the street view image currently displayed.

In one embodiment, the step of capturing the first and the second panoramic images according to the size of image plane to obtain a first image plane and a second image plane may include:

projecting the first and the second panoramic images onto the inner surface of a sphere, and capturing, according to the size of the image plane respectively, to obtain the original street view image and the target street view image.

In the embodiment, the first and the second panoramic images are projected, respectively, and the projection thereof are captured to obtain a first image plane and a second image plane, as well as the pixel value to display. Thus, the first image plane and the second image plane, i.e., the original street view image and the target street view image, are partial images of the first and the second panoramic images captured from a certain perspective and in a certain direction.

Projection before the step of capturing will effectively avoid the occurrence of obvious image distortion.

Furthermore, the first and the second panoramic images are positioned respectively inside the projection sphere, with the perimeter of the projection sphere similar or same to the widths of the panoramic images. When positioning the first image plane or the second image plane inside the projection sphere, the distance between the image plane and the sphere center is set to be the value of the focal length f. By intersections of the spherical surface and lines that start from the sphere center and pass through the image plane, the display pixel value of the image corresponding to the image plane can be obtained.

As shown in FIG. 4, in one embodiment, the Step S130 may further include:

Step S131, detecting a road extending direction of the original street view image.

In the embodiment, the scene in the original street view image is detected to obtain the corresponding extending direction of a road in the original street view image.

Step S133, matching the road extending direction with an inner rectangle of a rectangular box model, and constructing a rectangular box model in the original street view image with vanishing point corresponding to the road extending direction as the origin.

In the embodiment, the rectangular box model is the three-dimensional model of the original street view image. By matching the road extending direction with the inner rectangle of the rectangular box model, the scene in the road extending direction of the original street view image is placed into the inner rectangle, and the vanishing point determined according to the road extending direction is set as the origin of the rectangular box model. The vanishing point is the point where the road in an original street view image stretches to infinity, i.e., the converging point of the extension lines of both sides of the road.

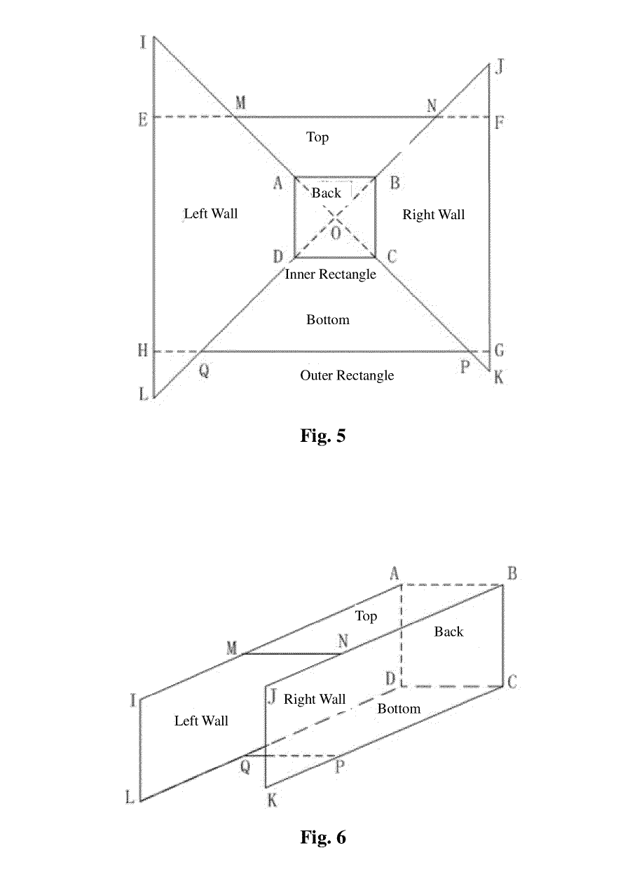

Furthermore, as shown in FIG. 5, the original street view image is divided into five regions: the inner rectangle, the left side face (the left wall), the right side face (the right wall), the bottom and the top. The street scene as a whole in the original street view image can be approximated by a rectangular box. As shown in FIG. 6, the bottom of the rectangular box model corresponds to the road in the original street view image, the left side face and the right side face corresponding respectively to the buildings on both sides of the road, and the top corresponding to the sky. Line segments QD and PC intersect at point O, which is the vanishing point. Meanwhile, images photographed by the virtual camera at the origin will be consistent with the original street view image. When the virtual camera is moving in the rectangular box model from the origin to a new viewpoint, three-dimensional effect will be obtained, by which the authenticity and accuracy of images photographed by the virtual camera and through the rectangular box model are guaranteed.

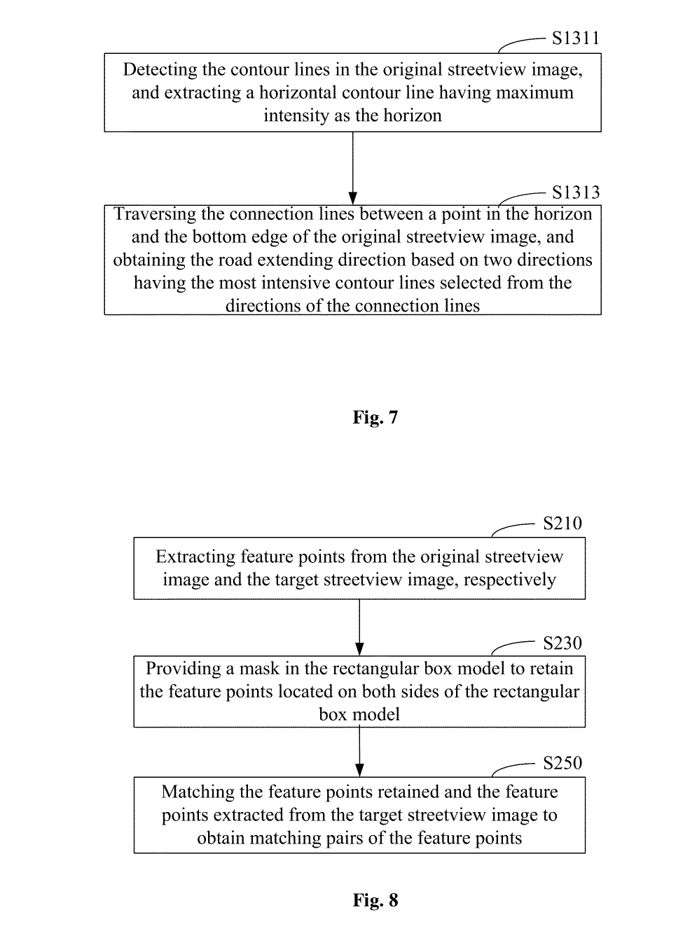

As shown in FIG. 7, in one embodiment, the Step S131 includes:

Step S1311, detecting the contour lines in the original street view image, and extracting a horizontal contour line having maximum intensity as the horizon.

In the embodiment, the profile is the part of the image with only the gradient retained, which is usually line-like, i.e., contour lines. For example, the edge of an object in contact with its background in an image presents a dramatic gradient change, thus it is possible detect contour lines contained in the image.

Contour lines in the original street view image are detected to obtain a horizontal contour line having a maximum intensity in the horizontal direction, which is further set as the horizon. In a preferred embodiment, the intensity of the contour lines in the horizontal direction in the original street view image may be detected in an order from the top to the bottom.

Step S1313, traversing the connection lines between a point in the horizon and the bottom edge of the original street view image, and obtaining the road extending direction based on two directions having the most intensive contour lines selected from the directions of the connection lines.

In the embodiment, connection lines between a point in the horizon and the bottom edge of the original street view image are traversed, with two directions having the most intensive contour lines selected from the directions of the connection lines determined as extending directions either side of the road, i.e., the road extending direction.

As shown in FIG. 8, in another embodiment, the method further includes, before Step S150, the step of:

Step S210, extracting feature points from the original street view image and the target street view image, respectively.

In the embodiment, the feature points extracted may be SIFT (Scale Invariant Feature Transform) feature points, or other feature points which shall not be limited hereto.

Step S230, providing a mask in the rectangular box model to retain the feature points located on both sides of the rectangular box model.

In the embodiment, in order to make the feature points extracted from the street view image and the subsequent processing more applicable to the street view image, a mask is provided in the rectangular box model to retain only the feature points in the left side face and right side face, which improves the speed and efficiency of the subsequent matching of the feature points.

Step S250, matching the feature points retained and the feature points extracted from the target street view image to obtain matching pairs of the feature points.

In the embodiment, the feature points are matched, so as to obtain the matching relationship between the feature points of the original street view image and the target street view image, and further obtaining matching pairs of the feature points.

Furthermore, after obtaining the feature points of the original and the target street view images, the RANSAC (Random Sample Consensus) algorithm, or other algorithms for matching feature points may be used.

Furthermore, after matching the feature points by the RANSAC algorithm, the matching relationship between feature points of the original and the target street view images as well as the corresponding homography matrix H will be obtained, and the obtained number of the matching pairs of the feature points and the homography matrix H are used to evaluate the effects of the current matching. That is, determine if the number of the matching pairs of the feature points reaches a threshold value, and if the rotational component of the homography matrix is less than a threshold value set for rotation. If the number of the matching pairs of the feature points is less than the threshold value, and the rotational component exceeds the set threshold value for rotation, then it is determined that the matching is less effective, and thus re-matching of the feature points is needed. For example, the number of matching pairs of the feature points calculated by RANSAC algorithm is usually 10 to 40; when the number currently obtained is less than the threshold value of 6, it indicates that the matching is less effective.

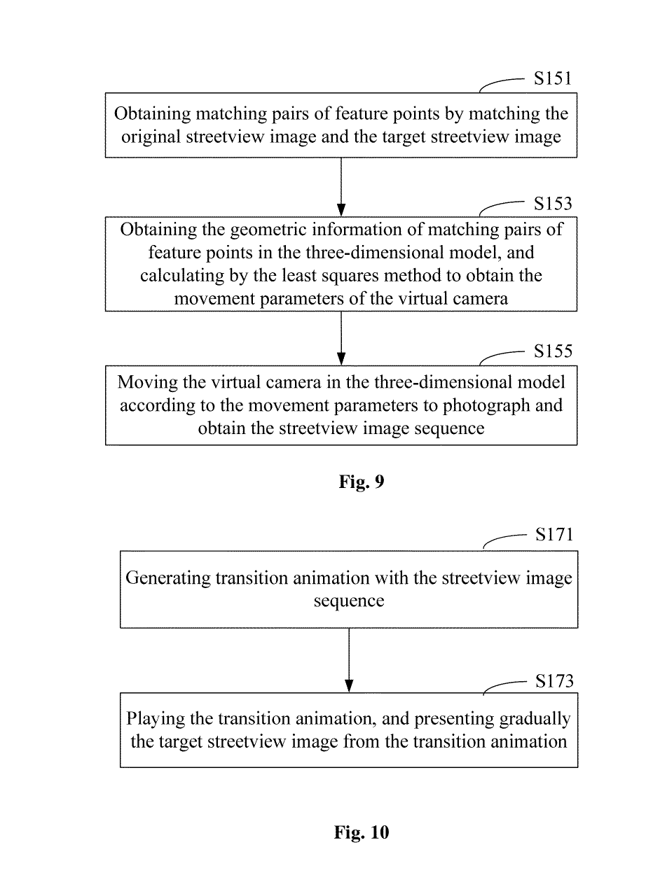

As shown in FIG. 9, in one embodiment, the Step S150 includes:

Step S151, obtaining matching pairs of feature points by matching the original street view image and the target street view image.

Step S153, obtaining the geometric information of matching pairs of feature points in the three-dimensional model, and calculating by the least squares method to obtain the movement parameters of the virtual camera.

In one embodiment, the geometric information of matching pairs of feature points in the three-dimensional model is the coordinates of the feature points in the three-dimensional model. In a matching pair of feature points, the feature point from the original street view image and the feature point from the target street view image are two same or similar points, so the geometric information of the two feature points will be the same, i.e., having the same position coordinate.

Since the feature points are in the same position in the three-dimensional model before and after transition of street view images, the following formula can be obtained according to the geometric relations of the top view:

$$y = \frac{{w}_{1}}{{w}_{1} - {m}_{y}} x - \frac{{m}_{z}}{( {w}_{1} - {m}_{y} ) f}$$

Wherein x and y represent the horizontal positions of the feature points of the original street view image and the target street view image in the matching pairs of feature points respectively, f represents the focal length used when the street view image is captured, w₁ represents the distance from the virtual camera before move to one side face, m_{y} and m_{z} represent the movement parameters calculated, m_{z} represents the distance moved from the front to the back, m_{y} represents the distance moved from the left to the right.

According to the geometric information of a plurality of matching pairs of feature points, movement parameters are calculated and obtained.

Furthermore, the GPS information of the camera location where the street view is photographed is obtained. According to the GPS information, the relationship between x and y are constrained to calculate and obtain the range of movement parameters.

For example, after photographing the original street view image, the camera moves forward for a distance to photograph the target street view image. If the advance distance of the camera is converted into pixel value of 170, then it can be calculated that the movement parameter m_{z} should be constrained within the range of 120 to 220 to ensure accuracy of the movement parameters.

Step S155, moving the virtual camera in the three-dimensional model according to the movement parameters to photograph and obtain the street view image sequence.

In the embodiment, the virtual camera is moved in the three-dimensional model according to the calculated movement parameters, so as to photograph and obtain the street view image sequence with a certain number of frames.

As shown in FIG. 10, in one embodiment, Step S170 includes:

Step S171, generating transition animation from the street view image sequence.

In the embodiment, a number of street view images are included in the street view image sequence. These street view images are configured to indicate different images from different viewpoints. As a result, transition animation having a certain number of frames is generated by a number of street view images included in the street view image sequence, so as to show the detailed process of conversion from the viewpoint where the original street view image is in to the viewpoint where the target street view image is in.

Furthermore, in the generated transition animation, the street view image shown by a number of the final frames will be the fused with the target street view image by based time-based linear opacity, so as to obtain the effects of gradual transition from the animation to the target street view image.

Furthermore, there may be large exposure difference between the original and the target street view images. As a result, the overall image exposure ratio of the original and the target street view images are calculated, and linearly multiplied according to time changes in the transition animation, so that the exposure of the street view images in the transition animation gradually converge with the target street view image without causing too obvious exposure jumping. This improves the authenticity of the switching of streetscape images.

Step S173, playing the transition animation, and presenting gradually the target street view image from the transition animation.

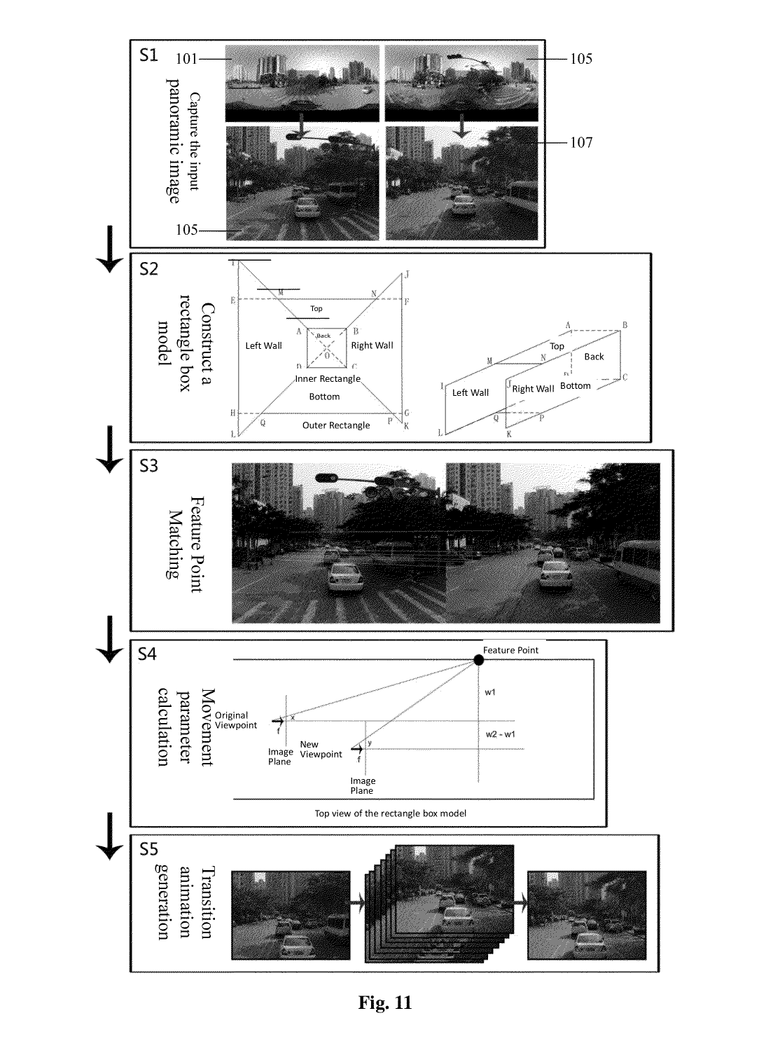

The method of the present disclosure will be better illustrated by the following embodiment described in detail. As shown in FIG. 11, in Step S1, a first panoramic image 101 and a second panoramic image 103 are captured to obtain an original street view image 105 and a target street view image 107. After obtaining the original street view image, step S2 will be implemented to construct a rectangle box model of the original street view image. In step S3, the feature points will be paired, so as to obtain a plurality of matching pairs of feature points and the corresponding geometric information in the rectangle box model.

In step S4, the movement parameters are calculated according to the top view of the rectangle box model. The virtual camera is moved in the rectangle box model according to the movement parameters, so as to photograph the street view image sequence. A transition animation is further generated by step S5. Transition between the original street view and the target street view are realized by the transition animation.

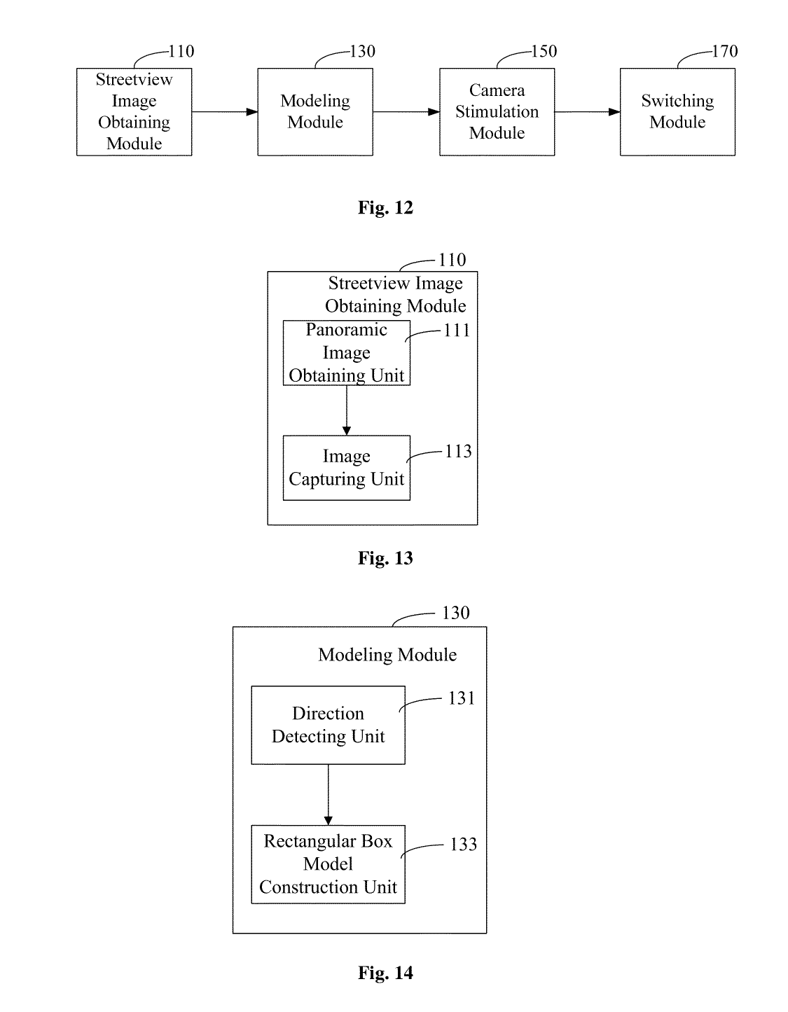

As shown in FIG. 12, a device for performing transition between street view images in one embodiment of the present disclosure includes a street view image obtaining module 110, a modeling module 130, a camera stimulation module 150 and a switching module 170.

The street view image obtaining module 110 is configured to obtain an original street view image and a target street view image.

In this embodiment, the original street view image is the street view image that is currently being displayed in the display window, and a target street view image is the street view image that is expected to be loaded and displayed. For example, the original street view image and the target street view image correspond respectively to two adjacent locations. When the user browses the original street view image in the display window and triggers an instruction of going to the next location, the target street view image will be loaded and displayed in the display window.

The modeling module 130 is configured to construct a three-dimensional model corresponding to the original street view image by three-dimensional modeling.

In this embodiment, the three-dimensional model of the original street view image may be constructed, by which the geometric information of each point of the original street view image may be obtained.

The camera stimulation module 150 is configured to obtain matching pairs of feature points that are extracted from the original street view image and the target street view image, and simulate a virtual camera in the three-dimensional model according to matching pairs of feature points to capture street view image sequence.

In the embodiment, each matching pair of feature points include both a feature point of the original street view image and a feature point of the target street view image, wherein the feature point of the target street view image matches that of the original street view image.

The camera stimulation module 150 is configured to a virtual camera is stimulated in the three-dimensional model according to the matching pairs of feature points and moved to shoot street view image sequence, the street view image sequence including a series of street view images obtained by shooting.

The switching module 170 is configured to switch from the original street view image to the target street view image according to the street view image sequence.

In one embodiment, the street view image sequence is played by the switching module 170 frame by frame starting from the original street view image, and street view images included in the street view image sequence are displayed one by one in the display window, so as to realize smooth transition from the original street view image to the target street view image, displaying to the user the natural and smooth transformation process between the original street view image and the target street view image.

As shown in FIG. 13, in one embodiment, the street view image obtaining module 110 comprises a panoramic image obtaining unit 111 and an image capturing unit 113.

The panoramic image obtaining unit 111 is configured to obtain a first panoramic image where the original street view image is located, and a second panoramic image where the target street view image is located.

In one embodiment, a panoramic image is a 360-degree picture photographed by a photographing device at a fixed point, whereas a street view image is obtained by a single shot, and thus is part of a panoramic image. A plurality of street view images can be spliced together to form a panoramic image.

The image capturing unit 113 is configured to obtain the original street view image and the target street view image by capturing the first and the second panoramic images respectively.

In this embodiment, an appropriate part of the first panoramic image is captured by the image capturing unit 113 as the original street view image, and an appropriate part of the second panoramic image is captured as the target street view image.

In one embodiment, the image capturing unit 113 is further configured to set the size of image plane according to the size of the display window, and capture according to the size of image plane to obtain a first image plane of the first panoramic image, and a second image plane of the second panoramic image, i.e., the original street view image and the target street view image.

In this embodiment, the display window is used to display images or pictures to the user. For example, the display window is the browser window.

The first and the second panoramic images are captured by the image plane obtaining unit 1131 according to the set size of image plane to obtain a first image plane and a second image plane, wherein the first image plane is the original street view image, and the second image plane is the target street view image.

In a preferred embodiment, in order to ensure the accuracy of image transition, the size of the image plane may be larger than the size of the display window. For example, if the size of the display window is (W, H), then the size of the image plane may be (λW, λH), wherein λ is a value greater than 1, typically set to be such as 2 or a larger value.

The size of the image plane is set by the image plane obtaining unit 1131 to be larger than the size of the display window, the image plane obtained by capturing the panoramic image will be larger than the image the user actually sees, which further allows smooth and accurate transition when the user is back-viewing the previous street view image from the street view image currently displayed.

In one embodiment, the image capturing unit 113 is configured to project the first and the second panoramic images onto the inner surface of a sphere, and capturing, according to the size of the image plane respectively, to obtain the original street view image and the target street view image.

In one embodiment, the first and the second panoramic images are projected by the image capturing unit 113, respectively, and the projection thereof are captured to obtain a first image plane and a second image plane, as well as the pixel value to display. Thus, the first image plane and the second image plane, i.e., the original street view image and the target street view image, are partial images of the first and the second panoramic images captured from a certain perspective and in a certain direction.

Projection before the step of capturing will effectively avoid the occurrence of obvious image distortion.

Furthermore, the first and the second panoramic images are positioned by the image capturing unit 113 respectively inside the projection sphere, with the perimeter of the projection sphere similar or same to the widths of the panoramic images. When positioning the first image plane or the second image plane inside the projection sphere, the distance between the image plane and the sphere center is set by a projection unit 1133 to be the value of the focal length f. By intersections of the spherical surface and lines that start from the sphere center and pass through the image plane, the display pixel value of the image corresponding to the image plane can be obtained.

As shown in FIG. 14, in one embodiment, the modeling module 130 includes a direction detecting unit 131 and a rectangular box model construction unit 133.

The direction detecting unit 131 is configured to detect a road extending direction of the original street view image.

In one embodiment, the scene in the original street view image is detected by the direction detecting unit 131 to obtain the corresponding extending direction of a road in the original street view image.

The rectangular box model construction unit 133 is configured to match the road extending direction with an inner rectangle of a rectangular box model, and construct a rectangular box model in the original street view image with vanishing point corresponding to the road extending direction as the origin.

In one embodiment, the rectangular box model is the three-dimensional model of the original street view image. The road extending direction is matched by the rectangular box model construction unit 133 with the inner rectangle of the rectangular box model, the scene in the road extending direction of the original street view image is placed into the inner rectangle, and the vanishing point determined according to the road extending direction is set as the origin of the rectangular box model. The vanishing point is the point where the road in an original street view image stretches to infinity, i.e., the converging point of the extension lines of both sides of the road.

Furthermore, the original street view image is divided by the rectangular box model construction unit 133 into five regions: the inner rectangle, the left side face (the left wall), the right side face (the right wall), the bottom and the top. The street scene as a whole in the original street view image can be approximated by a rectangular box, i.e. the rectangular box model construction unit 133. The bottom of the rectangular box model corresponds to the road in the original street view image, the left side face and the right side face corresponding respectively to the buildings on both sides of the road, and the top corresponding to the sky. Line segments QD and PC intersect at point O, which is the vanishing point. Meanwhile, images photographed by the virtual camera at the origin will be consistent with the original street view image. When the virtual camera is moving in the rectangular box model from the origin to a new viewpoint, three-dimensional effect will be obtained, by which the authenticity and accuracy of images photographed by the virtual camera and through the rectangular box model are guaranteed.

In one embodiment, the direction detecting unit 131 is further configured to detect the contour lines in the original street view image, extract a horizontal contour line having maximum intensity as the horizon, traverse the connection lines between a point in the horizon and the bottom edge of the original street view image, and obtain the road extending direction based on two directions having the most intensive contour lines selected from the directions of the connection lines.

In one embodiment, the profile is the part of the image with only the gradient retained, which is usually line-like, i.e., contour lines. For example, the edge of an object in contact with its background in an image presents dramatic gradient change, thus it is possible detect contour lines contained in the image.

The direction detecting unit 131 is configured to detect contour lines in the original street view image are detected to obtain a horizontal contour line having a maximum intensity in the horizontal direction, which is further set as the horizon. In a preferred embodiment, intensity of the contour lines in the horizontal direction in the original street view image may be detected by the direction detecting unit 131 in an order from the top to the bottom.

Connection lines between a point in the horizon and the bottom edge of the original street view image are traversed by the direction detecting unit 131, with two directions having the most intensive contour lines selected from the directions of the connection lines determined as extending directions either side of the road, i.e., the road extending direction.

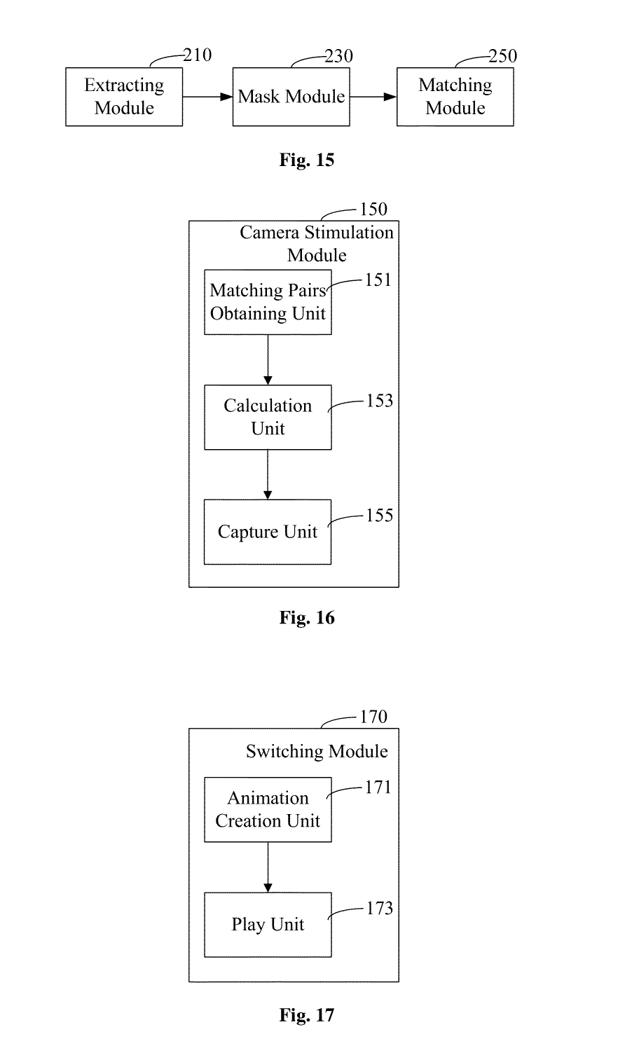

As shown in FIG. 15, in one embodiment, the device for performing transition between street view images further includes an extracting module 210, a mask module 230, and a matching module 250.

The extracting module 210 is configured to extract feature points from the original street view image and the target street view image, respectively.

In one embodiment, the feature points extracted by the extracting module 210 may be SIFT (Scale Invariant Feature Transform) feature points, or other feature points which shall not be limited hereto.

The mask module 230 is configured to provide a mask in the rectangular box model to retain the feature points located on both sides of the rectangular box model.

In one embodiment, in order to make the feature points extracted from the street view image and the subsequent processing more applicable to the street view image, a mask is provided by the mask module 230 in the rectangular box model to retain only the feature points in the left side face and right side face, which improves the speed and efficiency of the subsequent matching of the feature points.

The matching module 250 is configured to match the feature points retained and the feature points extracted from the target street view image to obtain matching pairs of the feature points.

In one embodiment, the feature points are matched by the matching module 250, so as to obtain the matching relationship between the feature points of the original street view image and the target street view image, and further obtaining matching pairs of the feature points.

Furthermore, after obtaining the feature points of the original and the target street view images, the RANSAC (Random Sample Consensus) algorithm, or other algorithms for matching feature points may be used by the matching module 250.

Furthermore, after matching the feature points by the RANSAC algorithm, the matching relationship between feature points of the original and the target street view images as well as the corresponding homography matrix H will be obtained by the matching module 250, and the obtained number of the matching pairs of the feature points and the homography matrix H are used to evaluate the effects of the current matching. That is, determine if the number of the matching pairs of the feature points reaches a threshold value, and if the rotational component of the homography matrix is less than a threshold value set for rotation. If the number of the matching pairs of the feature points is less than the threshold value, and the rotational component exceeds the set threshold value for rotation, then it is determined that the matching is less effective, and thus re-matching of the feature points is needed. For example, the number of matching pairs of the feature points calculated by RANSAC algorithm is usually 10 to 40; when the number currently obtained is less than the threshold value of 6, it indicates that the matching is less effective.

As shown in FIG. 16, in one embodiment, the camera stimulation module 150 includes a matching pairs obtaining unit 151, a calculation unit 153, and a capture unit 155.

The matching pairs obtaining unit 151 is configured to obtain matching pairs of feature points by matching the original street view image and the target street view image.

The calculation unit 153 is configured to obtain the geometric information of matching pairs of feature points in the three-dimensional model, and calculate by the least squares method to obtain the movement parameters of the virtual camera.

In one embodiment, the geometric information of matching pairs of feature points in the three-dimensional model is the coordinates of the feature points in the three-dimensional model. In a matching pair of feature points, the feature point from the original street view image and the feature point from the target street view image are two same or similar points, so the geometric information of the two feature points will be the same, i.e., having the same position coordinate.

Since the feature points are in the same position in the three-dimensional model before and after transition of street view images, the following formula can be obtained by the calculation unit 153 according to the geometric relations of the top view:

$$y = \frac{{w}_{1}}{{w}_{1} - {m}_{y}} x - \frac{{m}_{z}}{( {w}_{1} - {m}_{y} ) f}$$

Wherein x and y represent the horizontal positions of the feature points of the original street view image and the target street view image in the matching pairs of feature points respectively, f represents the focal length used when the street view image is captured, w₁ represents the distance from the virtual camera before move to one side face, m_{y} and m_{z} represent the movement parameters calculated, m_{z} represents the distance moved from the front to the back, m_{y} represents the distance moved from the left to the right.

According to the geometric information of a plurality of matching pairs of feature points, movement parameters are calculated and obtained by the calculation unit 153.

Furthermore, the GPS information of the camera location where the street view is photographed is obtained by the calculation unit 153. According to the GPS information, the relationship between x and y are constrained to calculate and obtain the range of movement parameters.

For example, after photographing the original street view image, the camera moves forward for a distance to photograph the target street view image. If the advance distance of the camera is converted into pixel value of 170, then it can be calculated that the movement parameter m_{z} should be constrained within the range of 120 to 220 to ensure accuracy of the movement parameters.

The capture unit 155 is configured to move the virtual camera in the three-dimensional model according to the movement parameters to photograph and obtain the street view image sequence.

In one embodiment, the virtual camera is moved by the capture unit 155 in the three-dimensional model according to the calculated movement parameters, so as to photograph and obtain the street view image sequence with a certain number of frames.

As shown in FIG. 17, in one embodiment, the switching module 170 includes an animation creation unit 171 and a play unit 173.

The animation creation unit 171 is configured to generate transition animation from the street view image sequence.

In one embodiment, a number of street view images are included in the street view image sequence. These street view images are configured to indicate different images from different viewpoints. As a result, the animation creation unit 171 generates the transition animation with a certain number of frames by using a number of street view images included in the street view image sequence, so as to show the detailed process of conversion from the viewpoint where the original street view image is in to the viewpoint where the target street view image is in.

Furthermore, in the generated transition animation, the street view image shown by a number of the final frames will be the fused by the animation creation unit 171 with the target street view image based on time-based linear opacity, so as to obtain the effects of gradual transition from the animation to the target street view image.

Furthermore, there may be large exposure difference between the original and the target street view images. As a result, the overall image exposure ratio of the original and the target street view images are calculated, and linearly multiplied by the animation creation unit 171 according to time changes in the transition animation, so that the exposure of the street view images in the transition animation gradually converge with the target street view image without causing too obvious exposure jumping. This improves the authenticity of the switching of streetscape images.

The play unit 173 is configured to play the transition animation, and present gradually the target street view image from the transition animation.

By the above method and device for performing transition between street view images, an original street view image and a target street view image are obtained, and a three-dimensional model corresponding to the original street view image is constructed by three-dimensional modeling; matching pairs of feature points that are extracted from the original street view image and the target street view image are obtained, according to which a virtual camera stimulation is performed in the three-dimensional model to capture street view image sequence; transition from the original street view image to the target street view image according to the street view image sequence is further performed. This eliminates the need of obtaining a pre-recorded transition video from the server, shields the influence of various factors, and improves the transition stability of street view images.

It should be noted that for a person skilled in the art, partial or full process to realize the methods in the above embodiments can be accomplished by related hardware instructed by a computer program, the program can be stored in a computer readable storage medium and the program can include the process of the embodiments of the above methods. The storage medium can be a non-transitory medium, such as a disk or a light disk. The program can also be stored in a Read-Only Memory or a Random Access Memory, etc.

The embodiments are chosen and described in order to explain the principles of the disclosure and their practical application so as to allow others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for performing transition between street view images, comprising:
obtaining an original street view image and a target street view image;
constructing a three-dimensional model corresponding to the original street view image by three-dimensional modeling;
obtaining matching pairs of feature points that are extracted from the original street view image and the target street view image, and simulating a virtual camera in the three-dimensional model according to the matching pairs of feature points to capture a street view image sequence; and
switching from the original street view image to the target street view image according to the street view image sequence.

2. The method of claim 1, wherein obtaining the original street view image and the target street view image comprises:
obtaining a first panoramic image where the original street view image is located, and a second panoramic image where the target street view image is located; and
obtaining the original street view image and the target street view image by capturing the first and the second panoramic images respectively.

3. The method of claim 2, wherein obtaining the original street view image and the target street view image by capturing the first and the second panoramic images respectively comprises:
setting a size of image plane according to a size of a display window, and capturing according to the size of image plane to obtain a first image plane of the first panoramic image as the original street view image, and a second image plane of the second panoramic image as the target street view image, and the size of the image plane is larger than the size of the display window.

4. The method of claim 3, wherein capturing according to the size of image plane to obtain the first image plane of the first panoramic image as the original street view image, and the second image plane of the second panoramic image as the target street view image comprises:
projecting the first and the second panoramic images onto an inner surface of a sphere, and capturing, according to the size of the image plane respectively, and obtaining the original street view image and the target street view image.

5. The method of claim 1, wherein constructing the three-dimensional model corresponding to the original street view image by three-dimensional modeling comprises:
detecting a road extending direction of the original street view image; and
matching the road extending direction with an inner rectangle of a rectangular box model, and constructing a rectangular box model in the original street view image with a vanishing point corresponding to the road extending direction as the origin.

6. The method of claim 5, wherein detecting the road extending direction of the original street view image comprises:
detecting contour lines in the original street view image, and extracting a horizontal contour line with maximum intensity as a horizon; and
traversing connection lines between a point in the horizon and the bottom edge of the original street view image, and obtaining the road extending direction based on two directions having the most intensive contour lines selected from the directions of the connection lines.

7. The method of claim 5, wherein before obtaining matching pairs of feature points that are extracted from the original street view image and the target street view image, and simulating the virtual camera in the three-dimensional model according to matching pairs of feature points to capture street view image sequence, the method further comprises:
extracting feature points from the original street view image and the target street view image, respectively;
providing a mask in the rectangular box model to retain the feature points located on both sides of the rectangular box model; and
matching the feature points retained and the feature points extracted from the target street view image and obtaining matching pairs of the feature points.

8. The method of claim 1, wherein obtaining matching pairs of feature points that are extracted from the original street view image and the target street view image, and simulating a virtual camera in the three-dimensional model according to matching pairs of feature points to capture the street view image sequence, comprises:
obtaining matching pairs of feature points by matching the original street view image and the target street view image;
obtaining geometric information of matching pairs of feature points in the three-dimensional model, and calculating by the least squares method to obtain movement parameters of the virtual camera;
moving the virtual camera in the three-dimensional model according to the movement parameters to photograph and obtain the street view image sequence.

9. The method of claim 1, wherein switching from the original street view image to the target street view image according to the street view image sequence, comprises:
generating a transition animation from the street view image sequence; and
playing the transition animation, and presenting gradually the target street view image from the transition animation.

10. A device for performing transition between street view images, comprising:
a street view image obtaining module, configured to obtain an original street view image and an target street view image;
a modeling module, configured to construct a three-dimensional model corresponding to the original street view image by three-dimensional modeling;
a camera stimulation module, configured to obtain the matching pairs of feature points extracted from the original street view image and the target street view image, and to simulate by a virtual camera in the three-dimensional model according to matching pairs of feature points to capture street view image sequence;
a switching module, configured to switch from the original street view image to the target street view image according to the street view image sequence.

11. The device of claim 10, wherein the street view image obtaining module comprises:
a panoramic image obtaining unit, configured to obtain a first panoramic image where the original street view image is located, and a second panoramic image where the target street view image is located; and
an image capturing unit, configured to obtain the original street view image and the target street view image by capturing the first and the second panoramic images respectively.

12. The device of claim 11, wherein the image capturing unit is further configured to set a size of image plane according to a size of the display window, and capture according to the size of image plane to obtain a first image plane of the first panoramic image as the original street view image, and a second image plane of the second panoramic image as the target street view image, and the size of the image plane is larger than the size of the display window.

13. The device of claim 11, wherein the image capturing unit is further configured to project the first and the second panoramic images onto an inner surface of a sphere, and capture, according to the size of the image plane respectively, and obtain the original street view image and the target street view image.

14. The device of claim 10, wherein the modeling module comprises:
a direction detecting unit, configured to detect a road extending direction of the original street view image; and
a rectangular box model construction unit, configured to match the road extending direction with an inner rectangle of a rectangular box model, and construct a rectangular box model in the original street view image with a vanishing point corresponding to the road extending direction as the origin.

15. The device of claim 14, wherein the direction detecting unit is further configured to detect contour lines in the original street view image, extract a horizontal contour line having maximum intensity as a horizon, traverse the connection lines between a point in the horizon and the bottom edge of the original street view image, and obtain the road extending direction based on two directions having the most intensive contour lines selected from the directions of the connection lines.

16. The device of claim 14, further comprising:
an extracting module, configured to extract feature points from the original street view image and the target street view image, respectively;
a mask module, configured to provide a mask in the rectangular box model to retain the feature points located on both sides of the rectangular box model; and
a matching module, configured to match the feature points retained and the feature points extracted from the target street view image and obtain matching pairs of the feature points.

17. The device of claim 10, wherein the camera stimulation module comprises:
a matching pairs obtaining unit, configured to obtain matching pairs of feature points by matching the original street view image and the target street view image;
a calculation unit, configured to obtain the geometric information of matching pairs of feature points in the three-dimensional model, and calculate by the least squares method to obtain the movement parameters of the virtual camera; and
a capture unit, configured to move the virtual camera in the three-dimensional model according to the movement parameters to photograph and obtain the street view image sequence.

18. The device of claim 10, wherein the switching module comprises:
an animation creation unit, configured to generate a transition animation from the street view image sequence; and
a play unit, configured to play the transition animation, and present gradually the target street view image from the transition animation.

19. A non-transitory computer-readable storage medium comprising an executable program, wherein the executable program, when executed, causes a computer to perform transition between street view images, the transition comprising:
obtaining an original street view image and a target street view image;
constructing a three-dimensional model corresponding to the original street view image by three-dimensional modeling;
obtaining matching pairs of feature points that are extracted from the original street view image and the target street view image, and simulating a virtual camera in the three-dimensional model according to the matching pairs of feature points to capture a street view image sequence; and
switching from the original street view image to the target street view image according to the street view image sequence.
